(19) United States
(12) Patent Application Publication
(10) Pub. No.: US 2008/0298064 A1
(43) Pub. Date: Dec. 4, 2008

(54) COLLAPSIBLE DECORATIVE LIGHT SYSTEM

(75) Inventor: Lewis CHENG, Hong Kong (CN)

Correspondence Address: TROUTMAN SANDERS LLP, 600 PEACHTREE STREET , NE, ATLANTA, GA, 30308, US

(73) Assignee: Cindex Holdings Limited (a Hong Kong corporation), Hong Kong (CN)

(21) Appl. No.: 12/132,119

(22) Filed: Jun. 3, 2008

Related U.S. Application Data
(60) Provisional application No. 60/941,739, filed on Jun. 4, 2007.

(51) Int. Cl. F21V 21/14

(52) U.S. Cl. 362/250

(57) ABSTRACT

A decorative light system including a first frame assembly, a second frame assembly, a thin profile assembly, and a light string system. Both the first frame assembly and the second frame assembly include a frame, which generally is a skeleton, and a sheet that is carried by the frame. The first frame assembly and the second frame assembly are connected to one another by the thin profile assembly, which can include at least one hinge. The thin profile assembly enables the decorative light system to collapse to a thin profile. The light string system is in communication with the second frame assembly, and the light string system includes wiring, a plurality of bulb assemblies. Each bulb assembly includes a socket system, and a light source to illuminate the light string system.

### CROSS REFERENCE TO RELATED APPLICATION

This application claims benefit under 35 U.S.C. § 119(e) of U.S. Provisional Patent Application Ser. No. 60/941,739 filed 04 Jun. 2007, the entire contents and substance of which is hereby incorporated by reference.

### BACKGROUND

1. Field of the Invention

Various aspects of the present invention relate to light systems and, more particularly, to decorative light systems.

2. Description of Related Art

Light systems are widely used in holidays, festivals, and celebrations. Conventionally, lights systems are arranged, for example, on a tree, door, or otherwise around the outside of a house during a holiday season. For example, Christmas lights are commonly known. For more versatile decorating purposes, various decorative light systems are disclosed in the prior art.

FIGS. 1A-1B are views of a prior art consumer product, which is commercially available. This conventional decorative light system 5 includes a background decoration of two candy canes tied together by a bow, wherein the decoration is lined at various points with lights.

This conventional decorative light system 5 includes a plurality of bulb assemblies 10, generally about the perimeter of the product. Each bulb assembly 10 includes a light bulb 15 housed in a light socket 20. Each light socket 20 is connected to a power source along a series-arranged light string 25, and is adapted to provide power received from a plug P to illuminate the light bulbs 15.

As shown in FIGS. 2A-2B this conventional decorative light system 5 is arranged such that the plurality of light bulbs 15 are inserted through a plurality of holes 30, and the background decoration preferably includes elements of an opaque, reflective material 35. Light system 5 hides the light socket 20, as it is positioned out of sight from the front of the product, behind the reflective material 35. The light bulbs 15 are inserted through the reflective material 35, and thus are viewable. In this arrangement, the light bulbs 15 of a conventional decorative light system 5 are positioned generally normal to the surface of the reflective material 35. Indeed, the socket 20 and hole 30 of the conventional system cooperate to maintain the bulbs normal the material 35.

Yet, disadvantageously, this arrangement minimizes reflection of light from the material and exposes the light bulbs to potential hazards, such as heavy snow and leaves. Further, the conventional decorative light system includes a single frame assembly, which requires the light to only reflect from the reflective material, such that no refraction of the light can occur.

Therefore, it can be seen that a need yet exists for an improved decorative light system. It is to such a device and method that the present invention is directed.

### SUMMARY

Briefly described, aspects of the present invention comprise a decorative light system including a first frame assembly, a second frame assembly, a thin profile assembly, and a light string system.

The first frame assembly comprises a first frame, which generally is a skeleton or support framework, and a first sheet carried by the first frame. The second frame assembly comprises a second frame, which also is generally a skeleton or support framework, and a second sheet that is carried by the second frame. The first and second sheets have a decorative feature, and can include, for example, transparent, translucent, and opaque portions.

The first frame assembly and the second frame assembly are in communication with one another by the thin profile assembly. The thin profile assembly is adapted to collapse or fold the first and second frame assemblies to a thin profile. The thin profile assembly can comprise at least one hinge. In an exemplary embodiment, there are at least two hinges, a first placed near the top of the decorative light system, and a second placed near the bottom of the decorative light system. The hinge(s) enables the decorative light system to collapse creating a thin profile.

The light string system is carried by the second frame assembly. The light string system comprises wiring, a plurality of bulb assemblies, each bulb assembly comprising a light source to illuminate the light string system, and a socket assembly.

These and other objects, features, and advantages of the present invention will become more apparent upon reading the following specification in conjunction with the accompanying drawings.

### BRIEF DESCRIPTION OF THE DRAWINGS

FIG. 1A is a front view of a conventional decorative light system.

FIG. 1B is a perspective view of the conventional decorative light system of FIG. 1A.

FIG. 2A is a perspective view of the installation of a bulb assembly in the conventional decorative light system of FIGS. 1A and 1B.

FIG. 2B is a perspective view of the installed bulb assembly in the conventional decorative light system of FIGS. 1A, 1B, and 2A.

FIG. 3 is a front view of a collapsible decorative light system, in accordance with an exemplary embodiment of the present invention.

FIG. 4 is a rear view of the collapsible decorative light system of FIG. 3, in accordance with an exemplary embodiment of the present invention.

FIG. 5 is a side perspective view of the collapsible decorative light system of FIGS. 3-4, in accordance with an exemplary embodiment of the present invention.

FIG. 6 is a top perspective view of the collapsible decorative light system of FIGS. 3-5 showing a hinge assembly, in accordance with an exemplary embodiment of the present invention.

FIG. 7 is a front perspective view of another collapsible decorative light system, in accordance with an exemplary embodiment of the present invention.

FIG. 8 is a side perspective view of the decorative light system of FIG. 7, in accordance with an exemplary embodiment of the present invention.

FIG. 9 is another side perspective view of the decorative light system of FIGS. 7-8, in accordance with an exemplary embodiment of the present invention.

FIG. 10 is a top perspective view of the decorative light system of FIGS. 7-9 showing the hinge assembly, in accordance with an exemplary embodiment of the present invention.

FIG. 11A is a side, partial cross-sectional view of a bulb assembly of the decorative light system, in accordance with an exemplary embodiment of the present invention.

FIG. 11B is a side, partial perspective view of the bulb assembly of the decorative light system of FIG. 11A, wherein the light bulb is seated in the socket assembly, in accordance with an exemplary embodiment of the present invention.

FIGS. 12A-12D are perspective views of a top surface of a second frame assembly illustrating installation of the bulb assembly in the decorative light system, in accordance with exemplary embodiments of the present invention.

FIGS. 12E-12F are perspective views of a bottom surface of the second frame assembly illustrating installation of the bulb assembly in the decorative light system, in accordance with exemplary embodiments of the present invention.

FIGS. 13A-13D are side views of installation of a cover around a socket of the bulb assembly, in accordance with an exemplary embodiment of the present invention.

### DETAILED DESCRIPTION

To facilitate an understanding of the principles and features of the invention, it is explained hereinafter with reference to its implementation in an illustrative embodiment. In particular, it is described in the context of being a collapsible system. The invention is also described in the context of collapsible decorative light system for the collapsing or folding of a light system.

The invention, however, is not limited to its use as a collapsible decorative light system. Rather, the invention can be used when a collapsible system is desired or necessary. Thus, the system described hereinafter as a collapsible system can also find utility as a system for other applications, beyond that of a light system.

The components described hereinafter as making up the various elements of the invention are intended to be illustrative and not restrictive. Many suitable components that would perform the same or a similar function as the materials described herein are intended to be embraced within the scope of the invention.

Referring now to the figures, wherein like reference numerals represent like parts throughout the views, the present invention will be described in detail. A collapsible decorative lights system is collapsible for safe keeping.

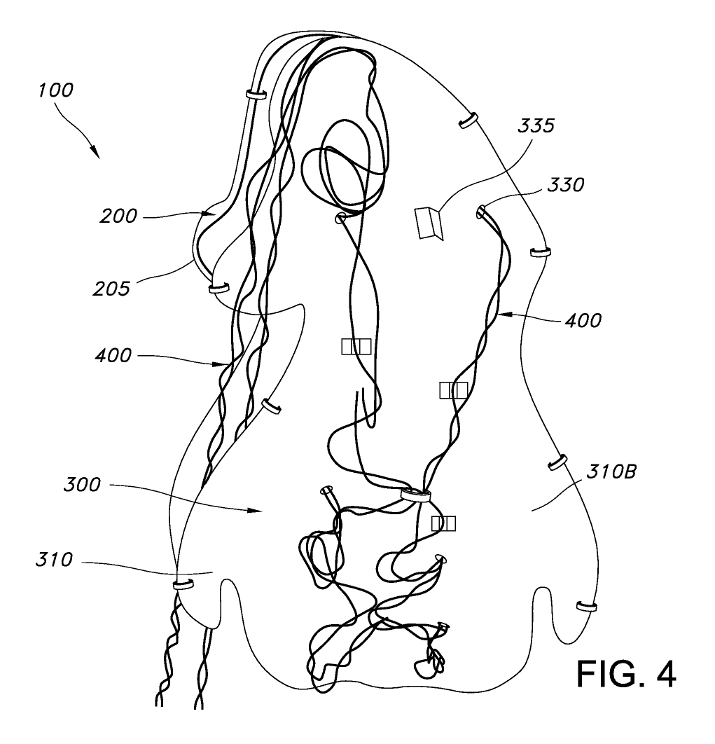

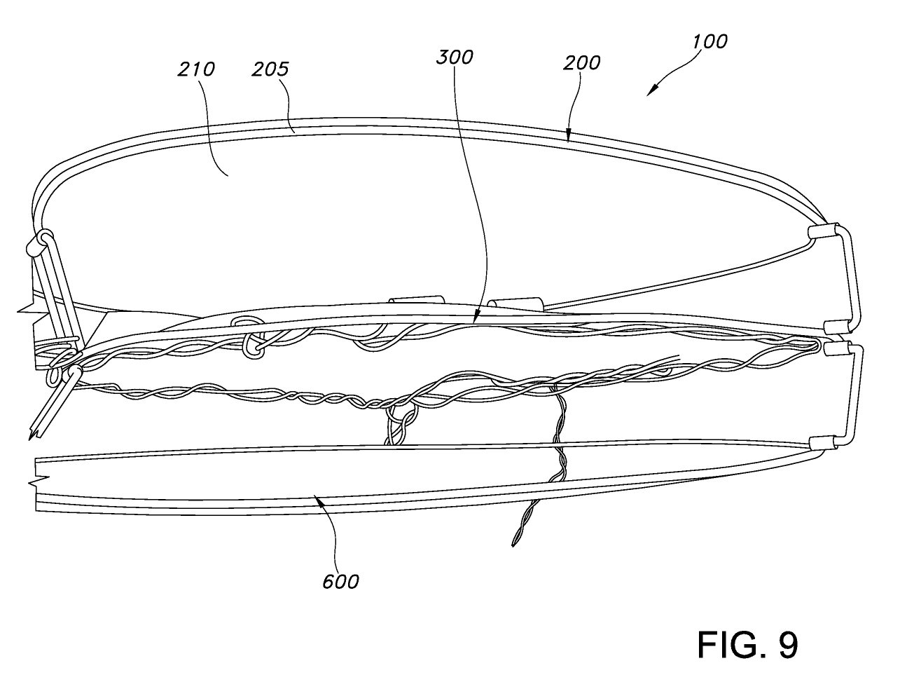

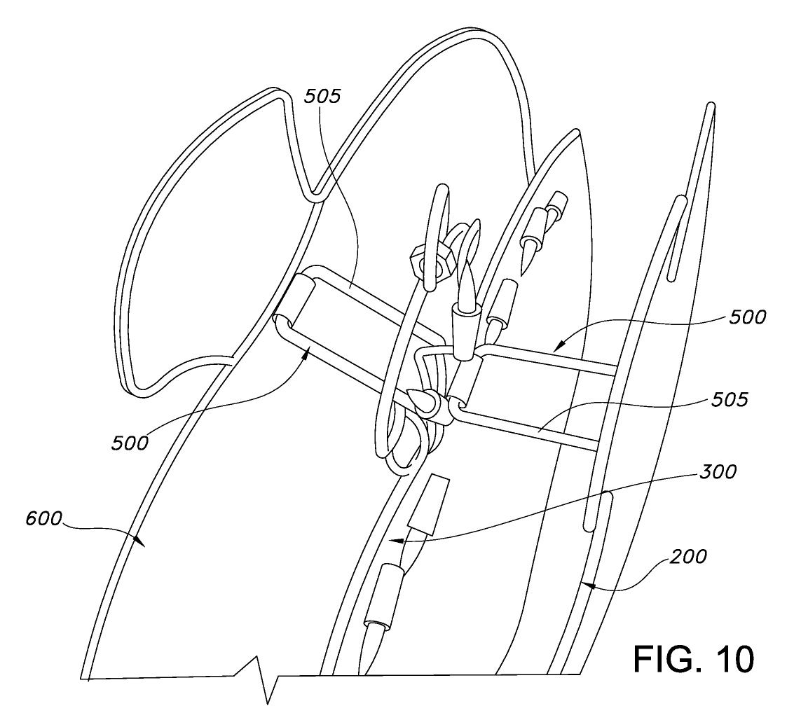

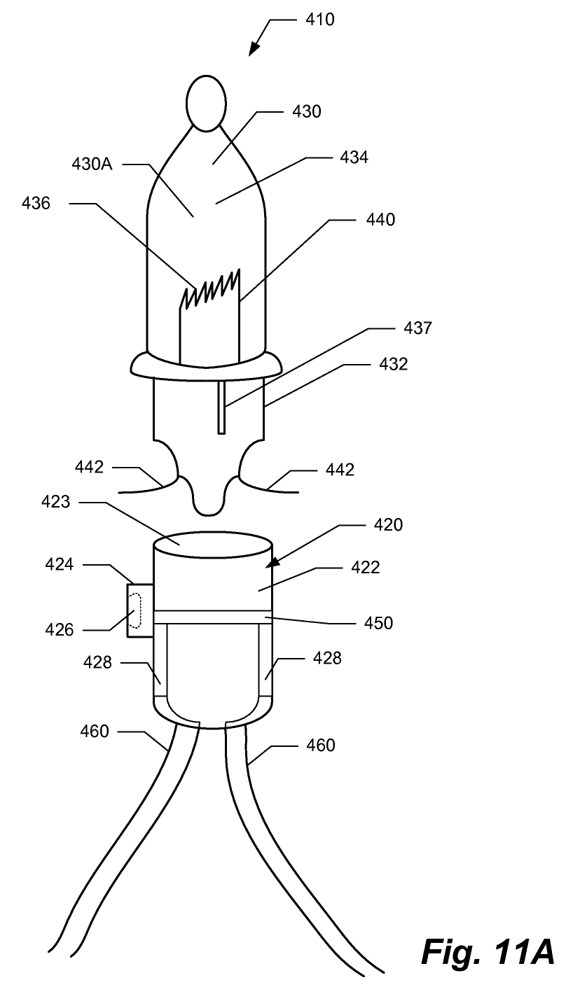

As shown in FIGS. 3-10, aspects of the present invention include a decorative light system 100 comprising a first frame assembly 200, a second frame assembly 300, a thin profile assembly 500, and a light string system 400.

The first frame assembly 200 of the decorative light system 100 comprises a first frame 205, which generally is a skeleton or support framework, and a first sheet 210 carried by the first frame 205.

The second frame assembly 300 comprises a second frame 305, which generally is a skeleton or support framework, and a second sheet 310 that is carried by the second frame 305.

The first frame assembly 200 and the second frame assembly 300 are connected to one another by a thin profile assembly 500, being a mechanism to enable the decorative light system 100 to have a thin profile in a collapsed state, for example, facilitating the bringing together of the first frame assembly 200 and the second frame assembly 300. In exemplary embodiments, the thin profile assembly 500 can perform as a collapsing assembly or a sliding assembly, both establishing a thin profile of the decorative light system 100. Additionally, the thin profile assembly 500 can be a hinge assembly, comprising a least one hinge mechanism 505. In an exemplary embodiment, there are two hinge mechanisms 505, a first placed near the top 105 of the decorative light system 100, and a second placed near the bottom 110 of the decorative light system 100. The thin profile assembly 500 can enable the decorative light system 100 to collapse to a thinner profile.

The light string system 400 is in communication with the second frame assembly 300. The light string system 400 comprises wiring 405, a plurality of bulb assemblies 410, each comprising a socket assembly 420, and a light source 430 to illuminate the light string system 400.

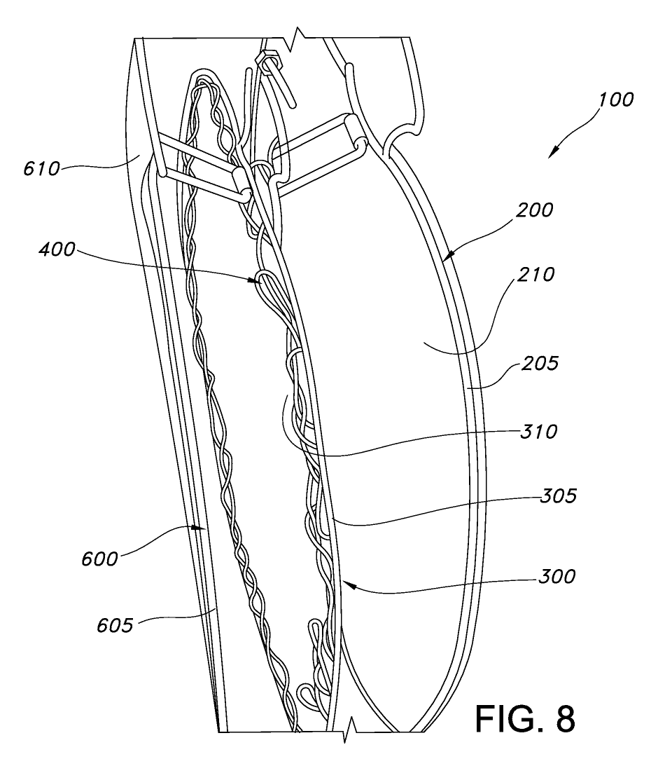

Often, the decorative light system 100 can provide decoration, because people enjoy decorating in the spirit of the holidays. As illustrated in the FIGS. 3-6, a design, such as a penguin or a plurality of penguins, can be an exemplary decorative light system 100 for a holiday, such as Christmas. As illustrated in FIGS. 7-10, a pumpkin or jack-o-lantern can be another exemplary decorative light system 100 for a holiday, such as Halloween.

The following is a list, for example and not limitation, of potential decorative light system designs: gifts, candy cane(s), Santa Claus, snowman, reindeer, Christmas tree(s), North Pole, elf, manger, cross, ornament, sled, holly, bells, stockings, star, candles, sack of gifts, wreath, mistletoe, and the like.

Christmas, however, is not the only holiday for which the decorative light system 100 can be designed. The holiday of Halloween can include decorative light systems 100, for example, illustrating black cat(s), ghost(s), witch(es), bat(s), pumpkin(s). The holiday of Thanksgiving can include decorative light systems 100, for instance, turkey, cornucopia, pilgrims, Indians, ships, and the like. Still other events, such as Independence Day, birthdays, and Easter can provide decorative light systems. Other examples can include flags (countries, sports teams, states, and the like) and spelled-out words (“Happy Birthday,” and “Congratulations”). The decorative light system 100 is capable of both use indoors and outdoors. One skilled in the art would appreciate that the decorative light system 100 can have many shapes and thus be many decorations.

A beneficial feature of the decorative light system 100 is its substantially flat arrangement. An exemplary width of the decorative light system in a collapsed form is less than one inch. The width, of course, is dependent on the number of frame assemblies incorporated into the design, and whether the decorative light system 100 is in a collapsed state or not.

Referring first to FIGS. 3-6, an exemplary embodiment of the present invention includes the decorative light system 100 having two frame assemblies 200 and 300, a thin profile assembly 500, and a light string system 400. As one skilled in the art would appreciate a plurality of frame assemblies can be implemented. There can be either two or three frame assemblies. The decorative light system 100 of FIGS. 3-6 implements two frame assemblies 200 and 300, while the decorative light system 100 of FIGS. 7-10 implements three frame assemblies 200, 300, and 600.

As shown in FIGS. 3-6, the first frame assembly 200 includes the first frame 205. The first frame 205 provides a relatively rigid border and shape that is a skeletal support to the decorative light system 100. The outside border of the first frame 205 can be dependent on the overall shape of the decorative light system 100. The first frame 205 can include a skeleton, or interior framework, which can be dependent on the design of the first sheet 210, used not only for providing proper support, but also for offsetting the overall design from one another.

The first frame 205 can be made of a metal, plastic, and the like to provide the stability needed for the decorative light system 100 to maintain its decorative shape. Preferably, the first frame 205 is white, but can be many alternative colors. As discussed, the first frame 205 need not be limited only to the border/perimeter of the design, but used internally not only to provide further rigidity, but also to aid in differentiation of color/designs, among sections. Portions of the first frame 205 can provide transition, displaying a three-dimensional depth of the decorative light system, and also provide borders of the design along color changes of the first sheet 210.

Referring now to FIG. 3, the first sheet 210 of the first frame assembly 200 can vary as to the amount of light that can pass therethrough. For example, the first sheet 210 can be transparent, translucent, or opaque, collectively implementing a recognizable design for which the decorative light system 100 represents. For instance, as shown in FIGS. 3, the decorative light system 100 is exemplarily illustrated as a penguin. The opaque portion 215 prohibits most, if not all, light from passing through the first sheet 210, while the translucent portion 220, however, permits some, if not most or all, light to pass through the first sheet 210.

The first sheet 210 can have reflective and/or refractive characteristics. If the first sheet 210 has reflective characteristics, the first sheet 210 can reflect or bounce light off the first sheet 210. If the first sheet 210 has refractive characteristics, the first sheet 210 can refract, or bend, light through the first sheet 210.

A suitable material, such as glass, PVC, or acrylic, for example, can be fused and distributed scatteringly and randomly on the skeleton of the first frame 205 in a thread-like state to thereby form a refracting layer for the first sheet 210. As a result, a dazzling light display, making the lighting more splendid and elegant, is created when light emitted from the light source 430 penetrates into and refracted through the first sheet 210.

The first sheet 210 can be cut by a laser to a size that fits about the first frame 205. Alternatively, the first sheet 210 can be manufactured to a predetermined size. The first sheet 210 can have a surface area slightly larger than the first frame 205, enabling the first sheet 210 to be secured to the first frame 205.

The first sheet 210 can be secured to the first frame 205 by a securing assembly 225, such as twist ties 227, zip ties, and the like. The first sheet 210 can also be adhered to the first frame 205 by many adhesives, such as glue, sealants, resins, bonding agents, and the like.

The second frame assembly 300 can be similar to the first frame assembly 200 of FIGS. 3-6. The second frame assembly 300 includes the second frame 305. The second frame 305 provides a relatively rigid border and shape that is a skeletal support to the decorative light system 100. The outside border of the second frame 305 can be dependent on the overall shape of the decorative light system 100. The second frame 305 can have generally the same shape as the first frame 205.

Like the first frame 205 of the first frame assembly 200, the second frame 305 of the second frame assembly 300 can be made of a metal, plastic, and the like to provide the stability needed for the decorative light system 100 to maintain its decorative shape. Preferably, the second frame 305 is white, but can be many alternative colors. As discussed, the second frame 305 need not be limited only to the border/perimeter of the design, but used internally not only to provide further rigidity, but also to aid in differentiation of color/designs, among sections.

In one embodiment, one or both of the first frame 205 and the second frame 305 can be positioned wholly behind the first sheet 210 and the second sheet 310, respectively, such that minimal portions, if at all, are viewable. In such embodiments, the first frame 205 and the second frame 305 provide the necessary support, but do not interfere with the viewing of the decorative light system 100. As one skilled in the art would appreciate, in another embodiment, the first frame 205 and the second frame 305 can be positioned in front of the first sheet 210 and the second sheet 310, respectively.

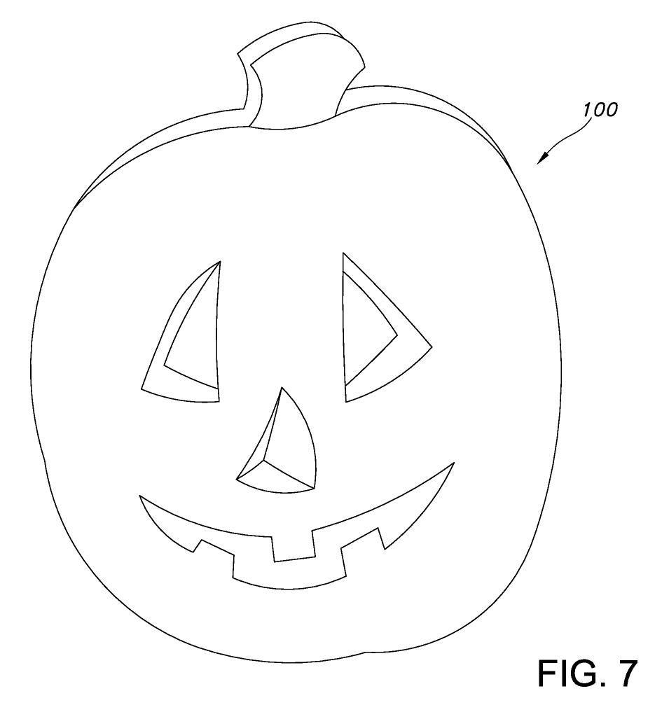

As shown in FIG. 6, the second frame assembly 300 can include one or more hanging devices 315 at its top for suspending the decorative light system 100. In other words, one or more hanging devices 315 can be coupled to the second frame assembly 300 for hanging the decorative light system 100. In an exemplary embodiment, the hanging device 315 can be an encircling member or a hook, enabling hanging, mounting, or suspending the decorative light system 100. For example, the decorative light system 100 can suspend from a ceiling, vertical surface (e.g., wall) or overhang via the hanging device 315.

The second sheet 310, also referred to as a background assembly, of the second frame assembly 300 can vary as to the amount of light that can pass therethrough. For example, the second sheet 310 can be transparent, translucent, or opaque, which collectively implements a recognizable design for which the decorative light system 100 represents.

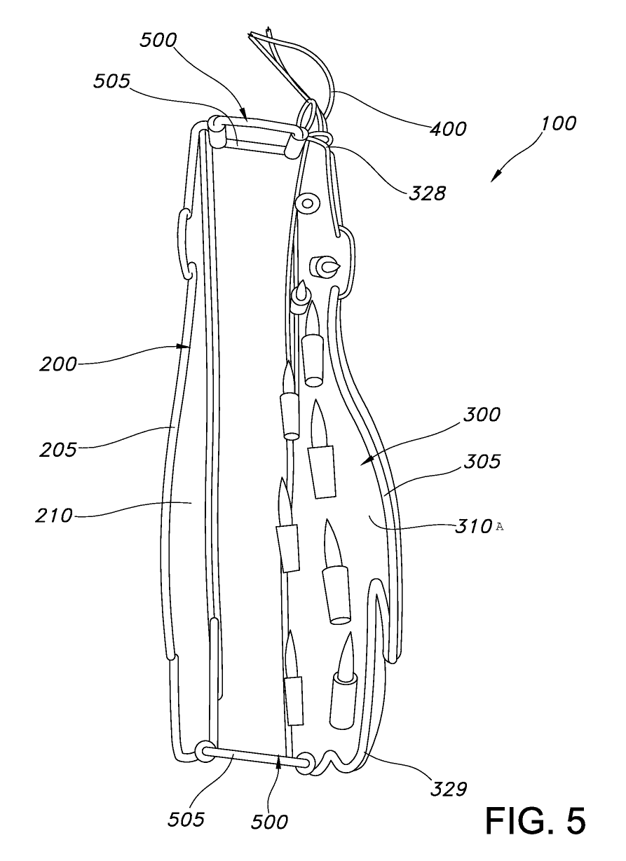

In one embodiment, as shown in FIGS. 3-6, the second sheet 310 can have a reflective surface such that light reflects off the second sheet 310. A first side 310A of the second sheet 310 reflects light towards the first sheet 210 of the first frame assembly 200. A second side 310B (see FIG. 4) of second sheet 310 is opaque, though it may still reflect some light.

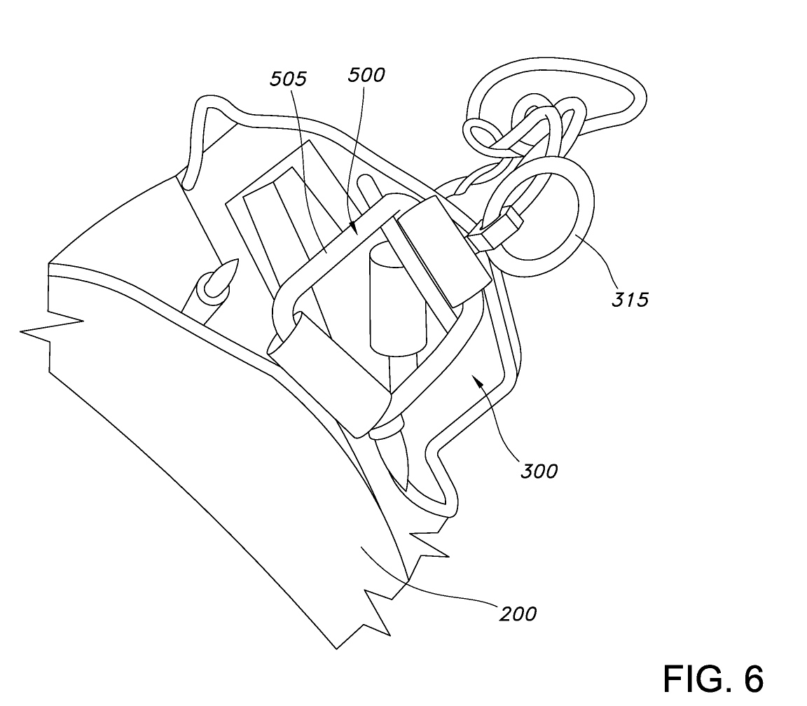

The second sheet 310 can include one or more portions that are have somewhat reflective and/or refractive characteristics. Those reflective surfaces can include a reflective sheet, as shown in FIGS. 5-6, a number of reflective stickers, a hologram, holographic colored sheets of paper, and the like. The reflective surface, or the second sheet 310, reflects light. The second sheet 310, however, need not comprise a fully reflective surface.

The second sheet 310 can, in combination or separate from the reflective sheet, include refractive features/characteristics. If the second sheet 310 has refractive characteristics, the second sheet 310 can refract, or bend, light through the second sheet 310.

Like the first sheet 210 of the first frame assembly 200, the second sheet 310 can also be cut to a predetermined size by a laser to fit about the second frame 305. Alternatively, the second sheet 310 can be manufactured to a predetermined size. In fact, the second sheet 310 can have a surface area slightly larger than the second frame 305, enabling the second sheet 310 to be secured to the second frame 305.

For instance, the second sheet 310 can be secured to the second frame 305 by a securing assembly 325, such as twist ties 327, zip ties, and the like. The second sheet 310 can also be adhered to the second frame 305 by many adhesives, such as glue, sealants, resins, bonding agents, and the like.

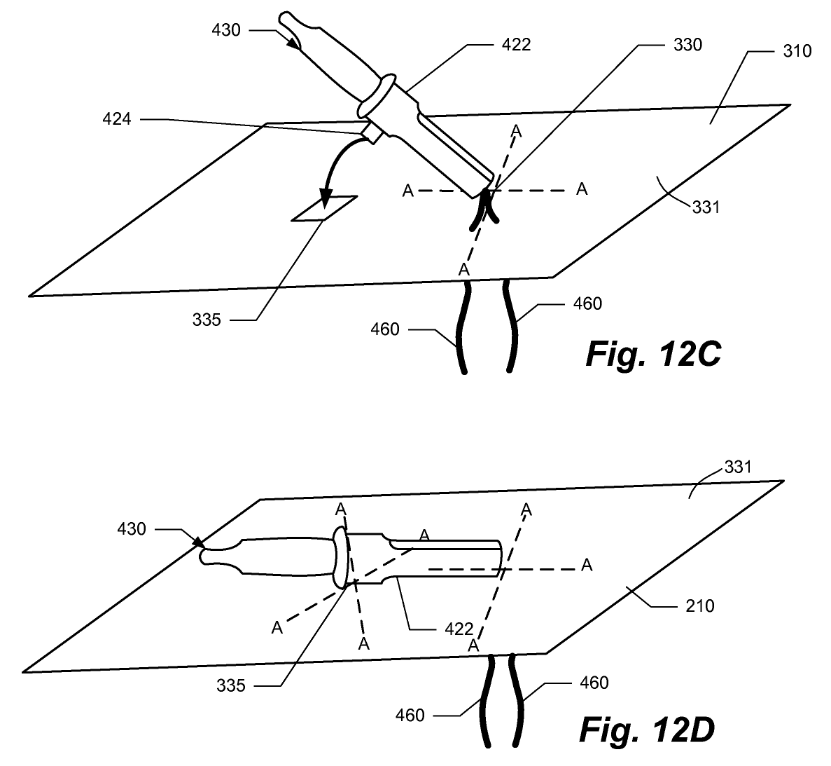

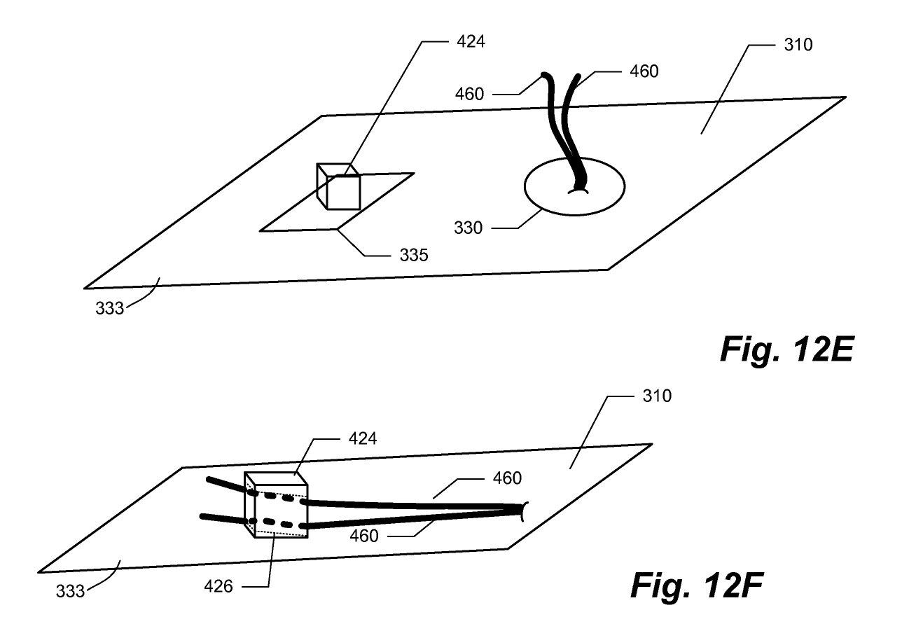

As shown in FIG. 4, the second sheet 310 can define a plurality of predetermined positioned apertures 330 extending through the second sheet 310 adapted to receive the bulb assemblies 410. The apertures 330 of the second sheet 310 are cooperatively shaped to receive the whole bulb assembly 410. Although the aperture 330 can include a loss of surface material, for example as shown in FIG. 12A-12B, the aperture 330 can also be a breach in the second sheet 310, such as cut lines A-A of FIG. 12C-12D, wherein the passage from behind the decoration to the front of the decoration is through the cut lines/slit A-A (such that there is minimal-to-no loss of surface material). In one embodiment, only one slit is provided. In other embodiments, more than one slit is provided. The length and orientation of the slit(s) are accommodating to the profile of the bulb assembly 410. Additionally, the second sheet 310 can have an extending member aperture 335 (or slit arrangement 335) for receiving an extending member 424 of the bulb assembly 410, which is described in detail hereinafter.

The decorative light system 100 further includes the light string system 400. The light string system includes the bulb, socket, and wiring of the system. It can include wiring 405 in communication with a plug P. The light string system 400 is electrically series-connected, though it can be electrically parallel-connected. Light string system 400 is in communication with the second frame assembly 300. That is, the light string system 400 can be carried by the second frame assembly 300.

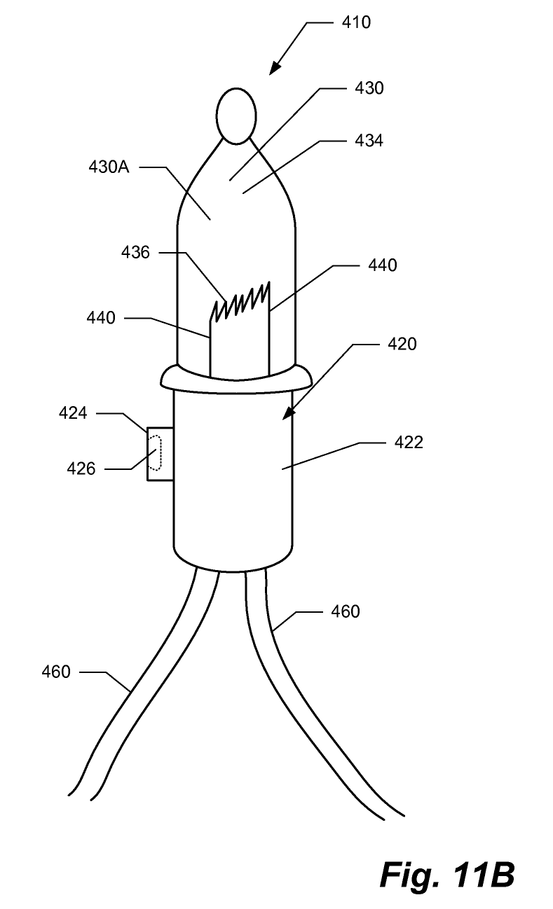

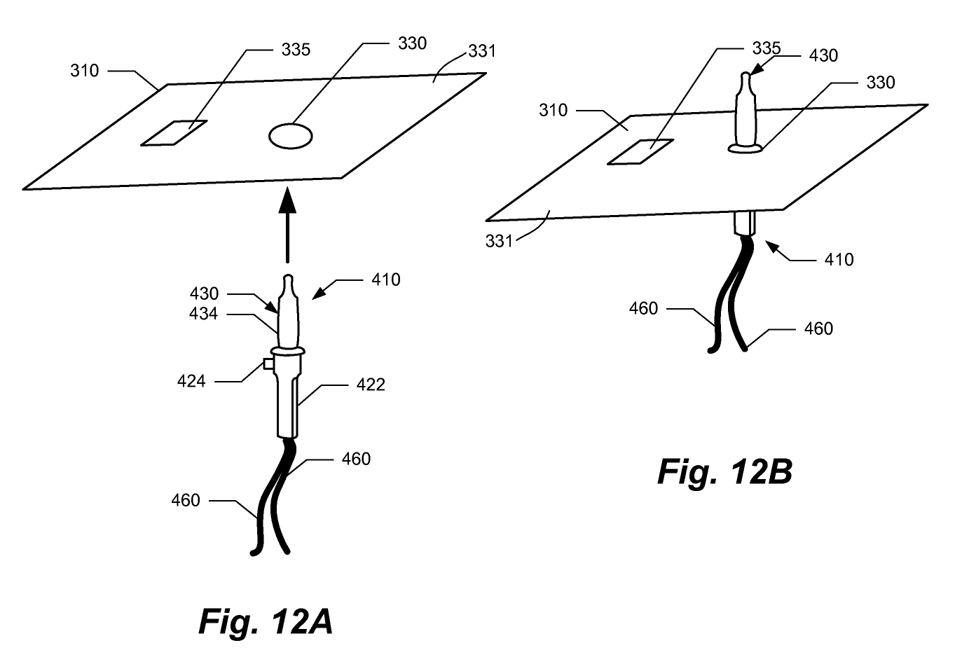

Referring now to FIGS. 11A-11B, the light string system 400 comprises a plurality of bulb assemblies 410, each bulb assembly 410 including a light source 430, a base 432, and a socket assembly 420. The light source 430 provides light when energized. One skilled in the art can appreciate that the light source 430 can be many types of light sources, including a light bulb, light emitting diode (LED), incandescent lamp, halogen lamp, fluorescent lamp, and the like. In one embodiment, the light source 430 is a light bulb 430A. The bulb assembly 410 can include a shunting mechanism to keep a light string system 400 illuminated, even if one of its light bulbs 430A burns out.

The light bulb 430A can include a globe 434 and a filament 436. The globe 434 is in communication with, and terminates at, the base 432. The globe 434 can be made of conventional translucent or transparent material such as plastic, glass, and the like. Typically, the globe 434 defines a hollow interior enabling protection of the filament 436. In a preferred embodiment, the color of the globe 434 can match or be similar to the color of the first sheet 210 of the first frame assembly 200. That is, the color of the globe 434 can be similar to the color of the sheet for which the globe 434 is in behind of, from the vantage of viewing the globe 434.

The filament 436, when charged with energy, can illuminate the light bulb 430A. Conductors 440 can be in electrical communication with the filament 436. The conductors 440 enable energy into the light bulb 430A to illuminate the filament 436, and thus the light bulb 430A. The conductors 440 extend down through the base 432, wherein the conductors 440 can be in communication with a pair of lead wires 442 external the base 432. The lead wires 442 extend through a bottom of the base 432, and are a pair of wires wrapped around the base 432 extending upwardly in the direction of globe 434, adjacent the base 432.

The bulb assembly 410 further includes the base 432. The base 432 can be integrally formed with the light source 430. The base 432 can be a unitary element of the light bulb 430A, or a separate element. The base 432 communicates between the light bulb 430A and an associated socket 422 of the socket assembly 420, complimenting and facilitating the seating of the light bulb 430A to the socket 422. The base 432 can incorporate at least one ridge 437 to ensure a snug fit with the socket 422, preventing the accidental disengagement of the light bulb 430A from the socket assembly 420. Other mechanical means can be used with the base 432 and the socket assembly 420 to ensure a tight fit.

The socket assembly 420 comprises the socket 422 adapted to receive the light bulb 430A/base 432. The socket 422 defines a cooperatively-shaped aperture 423 to receive the base 432 of the bulb assembly 410. The socket 422 can be arranged in many shapes and sizes, but as one skilled in the art will recognize, the socket 422 should be of a shape to conveniently receive the light bulb 430A/base 432.

The socket 422 includes a pair of socket terminals 428. The socket terminals 428 are located on opposing inner sides of the socket 422. The socket 422 further includes a pair of terminal wires 460 extending to the exterior to allow energy to enter (and exit) the socket 422. Each socket terminal is, essentially, an extension of each respective terminal wire 460. The terminal wire 460 extends through the bottom of the socket 422 and is ultimately connected to an electrical source.

Light strings, such as the decorative light system 100, are typically arranged with bulb assemblies 410 on the strings being electrically connected in series, rather than in a parallel arrangement. Unfortunately, there are disadvantages to designing a light string in series. When even a single light bulb is removed from a socket, the entire series of lights is rendered inoperable. Because each light bulb within its respective socket completes the electrical circuit, when a light bulb is removed or the filament of the bulb bums out, a gap is created in the circuit; that is, an open circuit is formed. Thus, electricity is unable to continue to flow through the circuit.

To overcome this dilemma, the socket assembly 420 can include a shunting device 450 to enable the energy flowing through the light string system 400 to continue to flow even when a light source 430 is absent from the socket 422. For instance, the light bulbs 430A in the light string system 400 will remain illuminated even though there may exist: an open filament 436, for example, a dead light bulb 430A, faulty or damaged light bulb 430A, faulty socket 422, or simply because the light bulb 430A is not properly mounted in its respective socket 422, or is entirely removed or falls out of its respective socket 422. For instance, the bypass activating system described in Massabki et al., U.S. Ser. No. 11/473,504, filed Jun. 23, 2006, the entire disclosure of which is incorporated herein by reference, can be used as the shunting device 450.

The socket assembly 420 can include an extending member 424, which is external to the socket 422. Upon light installation of the decorative light system 100, the extending member 424 being sufficiently sized, can be secured into an extending member slit/aperture 335 of the second sheet 310. The extending member aperture 335 is positioned adjacent to the slit/aperture 330, enabling the further securing of the bulb assembly 410 to the decorative light system 100. In one embodiment, the extending member 424 is approximately the same width as the diameter of the socket 422. The extending member 424 can also include a loop or grip 426. The grip 426 can be sufficiently sized to secure at least two terminal wires 460.

As shown in FIGS. 12A-12D, a top surface 331 of the second sheet 310 is illustrated, wherein a method of installing the bulb assembly 410 through and upon the second sheet 310 is further illustrated. FIG. 12A illustrates the aperture 330 to receive the bulb assembly 410. The globe 434 of the bulb assembly 410 is first inserted into the aperture 330 of the second sheet 310. Accordingly, the socket 422 next enters the aperture 330 of the second sheet 310, as illustrated in FIGS. 12B-12C. The bulb assembly 410 is then fully inserted through the aperture 330, including the socket 422 and extending member 424.

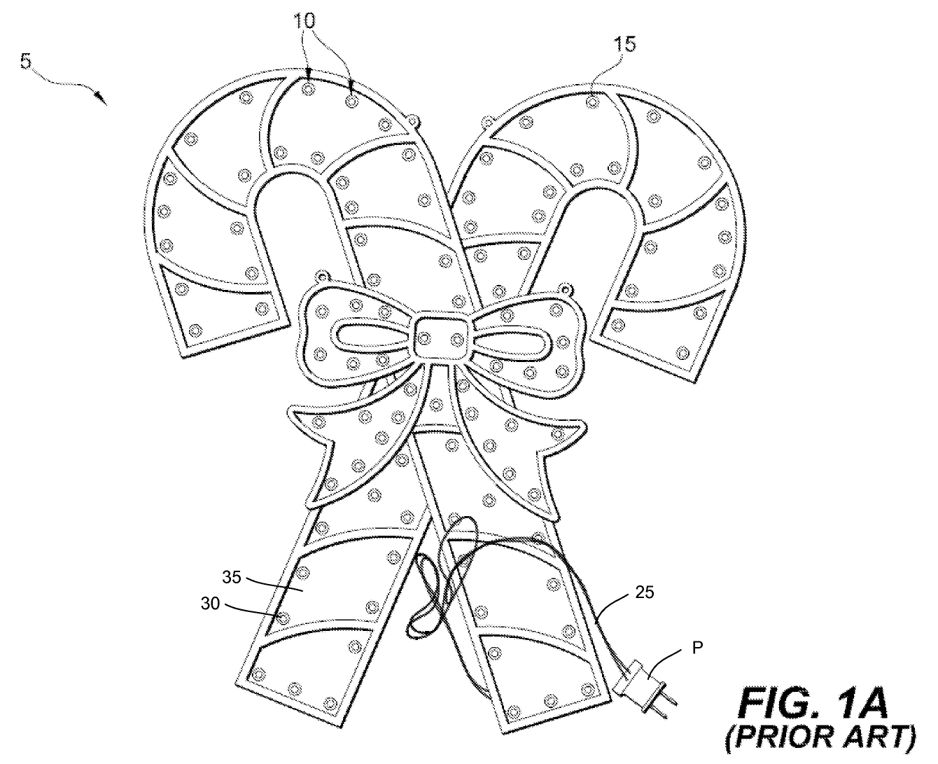

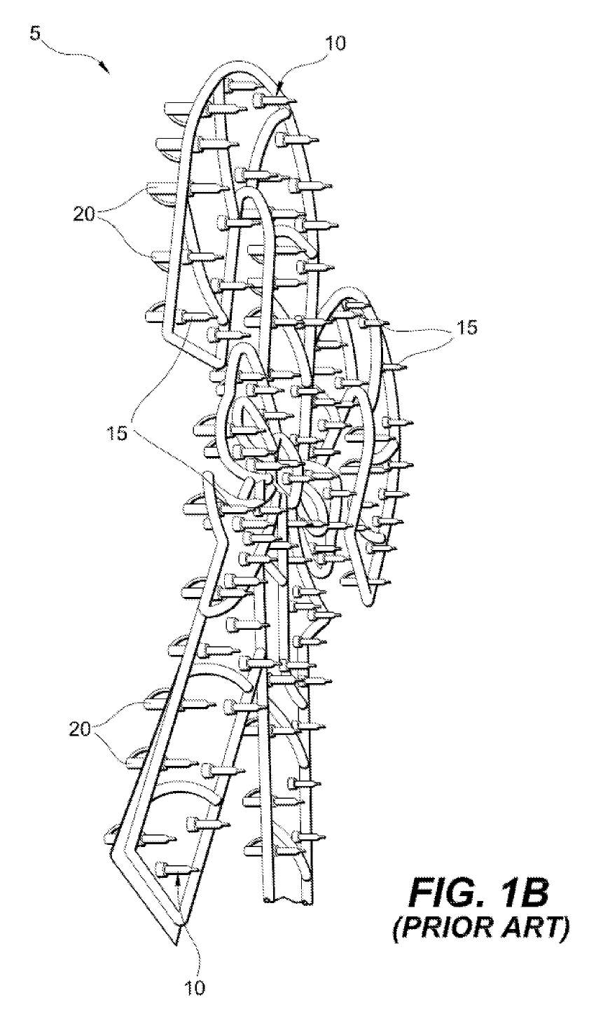

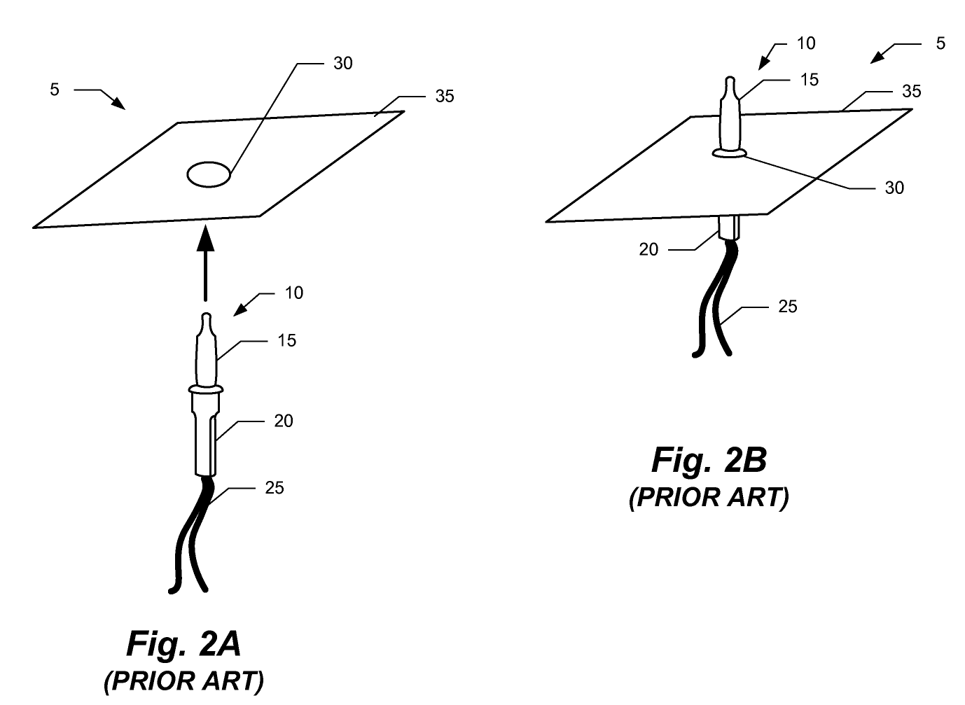

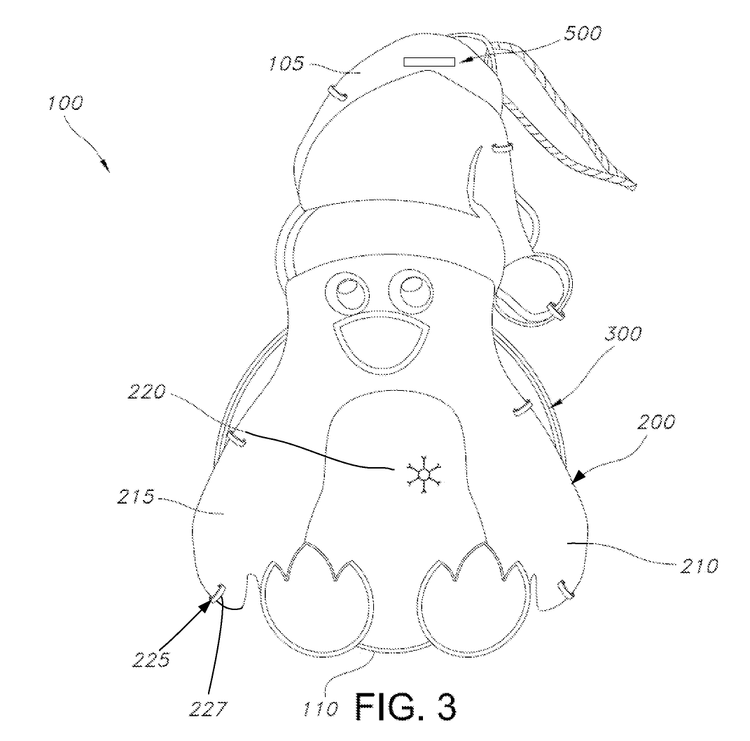

The extending member 424 can then be inserted into the extending member aperture 335. Not unlike aperture 330, extending member aperture 335 can include one or more slits. As illustrated in FIG. 12C, the light string system 400 is angled (as illustrated by the arrow) toward the second sheet 310 away from the conventional art of being normal to the top surface 331 (see FIGS. 1B and 2B). Here, the bulb assemblies 410 are substantially parallel to the top surface 328, than normal the top surface 328. That is, the bulb assemblies 410 are generally parallel to the top surface 331.

The bulb assembly 410 can essentially lie upon the second sheet 310, as shown in FIG. 17D. The bulb assembly 410 can indeed be positioned generally parallel to the surface of the second sheet 310. That is, the bulb assembly 410 can be generally co-planar to the second sheet 310. Such an orientation of bulb to surface can provide more reflected light than the prior art, and is thus more visually appealing.

The extending member 424, when locked in the extending member aperture (or breach) 335, can lock the bulb assembly 410 in the generally parallel arrangement to the second sheet 310. In addition, the extending member 424 can receive and/or grip a pair of terminal wires 460 of the light string system 400, further locking the bulb assembly 410 to the second sheet 310.

A bottom surface 333, or backside, of the second sheet 310 is illustrated in FIGS. 12E-12F. FIG. 12E depicts the wires 460 extending from the aperture 330, as well as the extending member 424 extending through the extending member aperture 335. The wires 460 can be secured within the grip 426, as shown in FIG. 12F. When the wires 460 are received by the grip 426, the bulb assembly 410 is further secured to the second sheet 310.

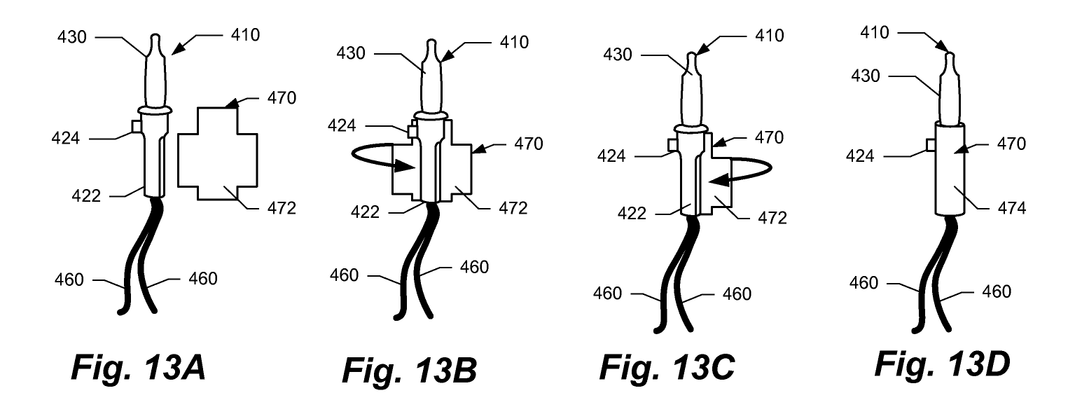

FIGS. 13A-13D depict a method of securing a cover 470 about the socket assembly 420. As described, the bulb assembly 410 and socket assembly 420 are inserted through the aperture 330 to lie upon the top surface 328 of the second sheet 310. Accordingly, the light source 430 and socket 422 are exposed to a viewer. In one embodiment, the socket assembly 420 is covered with a cover 470. The cover 470 has two sides—an inner side 472 and an outer side 474. The inner side 472 can have an adhesive to adhere the cover 470 to the socket assembly 420. The outer side 474 can have a reflective surface, similar in color and design to the second sheet 310. Thus, depending on the color of the second sheet 310 near the aperture 330, the outer side 474 of the cover 470 can have the same attributes. The bulb assembly 410 includes the globe 434 that has a similar color to the second sheet 310, and the socket assembly 420 being covered with the cover 470 that has a reflective surface having the same attributes of second sheet 310, which produces a seamless design of the decorative light system 100. The cover 470 can be wrapped around each of the socket assemblies 420. The cover 470 can be installed before or after the bulb assembly 410 and socket assembly 420 are inserted through the second sheet 310.

The socket assembly 420 can be comprised of color, such that the cover 470 is not needed to provide color to the socket assembly 420. Although, as one skilled in the art would appreciated, the cover 470 can still be implemented, as described above, even if the socket assembly 420 has such a color.

Referring now to FIGS. 3 and 5-6, the first frame assembly 200 is in communication with the second frame assembly 300 by a thin profile assembly 500, which enables the decorative light system 100 to collapse. The thin profile assembly 500 includes at least one hinge mechanism 505, though there can be more than one.

When there are two frame assemblies 200 and 300, there can be at least two hinge mechanisms 505. A first hinge mechanism 505 can be placed in proximity to the top 105 of the two frame assemblies 200 and 300. A second hinge mechanism 505 can be placed in proximity to the bottom 110 of the two frame assemblies 200 and 300. In an exemplary embodiment, the first frame assembly 200 folds upwardly, towards the top 105, such that the decorative light system 100 collapses. As one skilled in the art would appreciate, the first frame assembly 200 can be designed such that it alternatively folds downwardly, toward the bottom 110, to enable collapsing of the decorative light system 100.

The hinge mechanism(s) 505 is changeable between at least two states. For instance, the hinge mechanism(s) 505 are adapted to extend from a first state, or a closed position, wherein the decorative light system 100 is collapsed, to a second state, or an open position, wherein the decorative light system 100 is not collapsed. When the hinge mechanism 505 is in the closed position, the second frame assembly 300 is not distant from the first frame assembly 200 by the hinge mechanism 505; the decorative light system 100 is collapsed. Oppositely, when the hinge mechanism 505 is in the open position, the second frame assembly 300 is distant from the first frame assembly 200 by the hinge mechanism 505. One skilled in the art would appreciate that the thin profile assembly 500 can include a hinge mechanism, a sliding assembly, a collapsible assembly, wherein the frame assemblies can be collapsed or folded down to a thin profile.

The thin profile assembly 500 can enable the decorative light system 100 to decrease its width, enabling packing into smaller boxes/storage containers. By having a closed state, the first frame assembly 200 essentially supports and protects the light string system 400 carried by the second frame assembly 300.

When the decorative light system 100 is hanged by the hanging device 315, the thin profile assembly 500 can be changed from a closed state (for instance, if the decorative light system 100 was being stored) to an open state (for use). When the hanging device 315 is positioned to be hung, the hinge mechanism 505 of the thin profile assembly 500 is activated and extends to provide the desired distance between the frame assemblies.

Referring now to FIGS. 7-10, the decorative light system 100 includes three frame assemblies, the first frame assembly 200, the second frame assembly 300, and a third frame assembly 600. Both the first frame assembly 200 and the third frame assembly 600 are hinged to the second frame assembly 300, on opposing sides of the second frame assembly 300. In one embodiment, the first frame assembly 200 and the third frame assembly 600 have the same features.

The first frame assembly 200 and the third frame assembly 600 include a first frame 205 and a third frame 605, respectively, and a first sheet 210 and third sheet 610, respectively. Both the first sheet 210 and the third sheet 610 can have translucent, transparent, opaque reflective, or refractive characteristics.

The second frame assembly 300 can be translucent, such that light emitted from the light string system 400 can penetrate through to reach both the first frame assembly 200 and the third frame assembly 600.

The decorative light system 100 of FIGS. 7-10 has characteristics similar to those of the decorative light system of FIGS. 3-6. The decorative light system 100 of FIGS. 7-10, however, includes the third frame assembly 600 and a generally translucent sheet for the second sheet 310 of the second frame assembly 300, enabling the light to illuminate towards and, partially, through the first frame assembly 200 and the third frame assembly 600.

In an exemplary embodiment, the first frame assembly 200 is in communication with the second frame assembly 300 via the thin profile assembly 500, and the third frame assembly 600 is in communication with the second frame assembly 300 via the thin profile assembly 500. The thin profile assembly 500 enables the first frame assembly 200 to collapse towards the second frame assembly 300, and the third frame assembly 600 to collapse towards the second frame assembly 300. As a result, the decorative light system 100 can collapse into a thinner profile.

While the invention has been disclosed in its preferred forms, it will be apparent to those skilled in the art that many modifications, additions, and deletions can be made therein without departing from the spirit and scope of the invention and its equivalents, as set forth in the following claims.

What is claimed is:

1. A decorative light system comprising:
a first frame assembly comprising a first frame and a first sheet coupled to the first frame;
a second frame assembly comprising a second frame and a second sheet coupled to the second frame; and
a thin profile assembly in communication with both the first frame assembly and the second frame assembly, the thin profile assembly enables the first and second frame assemblies to collapse to a thin profile.

2. The decorative light system of claim 1, further comprising a light string system comprising a plurality of bulb assemblies in electrical communication with one another.

3. The decorative light system of claim 2, the light string system carried by the second frame assembly.

4. The decorative light system of claim 1, further comprising:
a light string system comprising a plurality of bulb assemblies electrically connected to one another, each of the plurality of bulb assemblies comprising a socket assembly, a light source, and an extending member extending outwardly from the socket assembly;
the second sheet of the second frame assembly defining a plurality of bulb apertures sized for receiving the bulb assemblies therethrough, and the second sheet defining a plurality of extending member apertures sized for receiving the extending members of the socket assembly therethrough,
wherein the plurality of bulb assemblies are insertable through the plurality of bulb apertures of the second sheet,
wherein the extending member of each of the plurality of bulb assemblies are received by the extending member apertures on the second sheet of the second frame assembly, and
wherein the plurality of bulb assemblies are positioned substantially parallel with the second sheet of the second frame assembly.

5. The decorative light system of claim 4, the extending member receiving by the extending member aperture locks the bulb assembly in the substantially parallel position.

6. The decorative light system of claim 4, the extending member receiving a pair of wires of the light string system on an opposing side of the second sheet of the second frame assembly for securing the bulb assembly to the second sheet, and for hiding the pair of wires from view.

7. The decorative light system of claim 4, the socket assembly of the light string system is wrapped with a cover having similar attributes of the second sheet of the second frame assembly.

8. The decorative light system of claim 7, the cover wrapped about the socket assembly has the same color as the second sheet of the second frame assembly.

9. The decorative light system of claim 1, the first sheet of the first frame assembly comprising at least two portions that vary as to the amount of light that passes therethrough.

10. The decorative light system of claim 9, the first sheet comprising transparent, translucent, or opaque portions.

11. The decorative light system of claim 1, the first sheet comprising reflective or refractive characteristics.

12. The decorative light system of claim 1, further comprising a third frame assembly comprising a third frame and a third sheet, the third frame assembly in communication with the second frame assembly via the thin profile assembly.

13. The decorative light system of claim 1, the thin profile assembly comprising at least one hinge mechanism comprising a collapsed state and an open state.

14. The decorative light system of claim 13, further comprising a hanging device in communication with a top of the second frame assembly.

15. The decorative light system of claim 14, wherein when the hanging device is activated to support the decorative light system as the hinge mechanism changes states.

16. A decorative light system comprising:
a first frame assembly comprising a first frame and a first sheet coupled to the first frame;
a second frame assembly comprising a second frame and a second sheet coupled to the second frame;
a thin profile assembly in communication with both the first frame assembly and the second frame assembly, the thin profile assembly enables the first and second frame assemblies to collapse to a thin profile; and
a light string system comprising a plurality of bulb assemblies electrically connected to one another, each of the plurality of bulb assemblies comprising a socket assembly, a light source, and an extending member extending outwardly from the socket assembly.

17. The decorative light system of claim 16, the second sheet defining a plurality of bulb apertures sized for receiving the bulb assemblies therethrough, and the second sheet defining a plurality of extending member apertures sized for receiving the extending members of the socket assembly therethrough.

18. The decorative light system of claim 17, wherein the plurality of bulb assemblies are insertable through the plurality of bulb apertures of the second sheet, wherein the extending member of each of the plurality of bulb assemblies are received by the extending member apertures on the second sheet of the second frame assembly, and wherein the plurality of bulb assemblies are positioned substantially parallel with the second sheet of the second frame assembly.

19. The decorative light system of claim 16, further comprising a third frame assembly comprising a third frame and a third sheet, the third frame assembly in communication with the second frame assembly.

20. The decorative light system of claim 16, the thin profile assembly comprising a hinge mechanism that comprises a closed state and an open state for varying the distance between the first and second frame assemblies.
